(19) United States
(12) Patent Application Publication
(10) Pub. No.: US 2025/0136786 A1
(43) Pub. Date: May 1, 2025

(54) STABILIZERS FOR POLYHYDROXYALKONOATES

(71) Applicant: Novomer, Inc., Rochester, NY (US)

(72) Inventor: Christopher A. DeRosa, Rochester, NY (US)

(21) Appl. No.: 18/835,904

(22) PCT Filed: Feb. 10, 2023
(86) PCT No.: PCT/US2023/012798

§ 371 Date: Aug. 5, 2024

Related U.S. Application Data
(60) Provisional application No. 63/309,060, filed on Feb. 11, 2022.

(51) Int. Cl. C08K 5/092; C08K 5/00; C08K 5/095; C08K 5/1539; C08K 5/37

(52) U.S. Cl. CPC C08K 5/092; C08K 5/005; C08K 5/095; C08K 5/1539; C08K 5/37

(57) ABSTRACT

A composition comprising a polyhydroxyalkonoate (PHA) and a stabilizer comprising one or more of an aliphatic carboxylic acid having a hydroxyl or thiol group, a cyclic anhydride, or a halo carboxylic acid may be formed by contacting the PHA and stabilizer and intermixing them so that the stabilizer is incorporated into the PHA to stabilize PHA. Typically, the PHA is melted, and the stabilizer added before much if any degradation (i.e., reduction of molecular weight occurs). The aliphatic carboxylic acid having a hydroxyl group may be naturally occurring and may be particularly useful for applications having human or food contact or particular environmental constraints.

### BACKGROUND

Polyester polymers have proven to be versatile materials with a wide range of uses. Polyesters based on petroleum-derived aromatic monomers are among the most widely utilized polymers, for example polyethylene terephthalate (PET) is produced on massive scale to produce water bottles, textiles and other consumer goods. Unfortunately, PET is not biodegradable and as such has become a major contributor to the growing problem of environmental contamination by residual post-consumer plastic wastes, including damage to marine ecosystems. In recent years there has been increasing interest in biodegradable polyesters, examples include polylactic acid (PLA) and polyhydroxyalkanoates (PHAs), such as poly-3-hydroxybutyrate (P3HB). PHA's typically are synthesized by manipulating the enzymatic pathways of microorganisms resulting in high cost and properties (e.g., high molecular weights that tend to make them difficult to process). These problems have made it difficult to serve large volume applications to displace incumbent high-volume polymers. There remains a need for high performance biodegradable polymers and for methods of making such polymers from flexible feedstock sources that allow manufacturers to balance the cost and sustainability their products.

While polyesters have useful properties, the polyesters of lactones (“polylactones” herein) have tended to suffer from thermal degradation when processing to form them into useful articles (melt extrusion, blowing, and molding for example).

Accordingly, it would be desirable to provide a method that overcome previously described limitations to provide PHAs particularly those derived at least in part from ring opening polymerization of lactones and in particular polymers of beta-propiolactone that may be used in a myriad of applications including those in the food and health care industries.

### SUMMARY

Applicant has discovered effective stabilizers/additives that may be incorporated into the PHA upon thermal processing reducing the degradation of the polymer at processing temperatures (i.e., substantially minimizing the reduction of molecular weight). For example, a PHA powder and stabilizer powder may be mixed dry and then heated or dissolved to form the composition disclosed. The stabilizer may be added to a molten PHA and formed into an article. The stabilizer may avoid the formation of hazardous by-products or avoid washing altogether. Naturally occurring carboxylic acids that are safe for foods (e.g, acids occurring in fruit) are particularly useful for applications with contact with food or other environmental constraints.

A first aspect disclosed is a composition comprising a polyhydroxyalkonoate and a stabilizer comprising one or more of an aliphatic carboxylic acid having a hydroxyl or thiol group, a cyclic anhydride, or a halo carboxylic acid.

A method comprising,
(i) contacting a polyhydroxyalkonoate and one or more stabilizers comprising an aliphatic carboxylic acid having a hydroxyl or thiol group, a cyclic anhydride, and a halo carboxylic acid
(ii) intermixing the polyhydroxyalkonoate and the polyhydroxyalkonoate aliphatic carboxylic acid.

The compositions and methods may be used to make a PHAs having a wide range of weight average molecular weights (Mw). The ability to target the Mw as well as control the weight distribution (polydispersity) using the stabilizers allows for polymer characteristics that may be used in multiple applications (e.g., films, coatings, composites, fibers and articles made therefrom). The compositions may be used in applications taking advantage of polymeric materials and include, but are not limited, to industries such as health care, food production/storage and preparation, transportation (e.g., trucks, buses, RVs, trailers, bicycles, motorcycles and automobiles), chemical, materials, and aerospace.

### DESCRIPTION OF THE DRAWINGS

FIG. 1 is a plot of molecular weight reduction of a PHA with and without a stabilizer disclosed as function of time at an elevated temperature.

The data for the phthalate and comparative samples tested at 120° C. is shown in FIG. 2.

The data for the phthalate and comparative samples tested at 140° C. is shown in FIG. 3.

### DETAILED DESCRIPTION

### Definitions

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain polymers disclosed can comprise one or more asymmetric centers, and thus can exist in various stereoisomeric forms, e.g., enantiomers and/or diastereomers. The polymers and compositions thereof may be in the form of an individual enantiomer, diastereomer or geometric isomer, or may be in the form of a mixture of stereoisomers. The polymers disclosed may be enantiopure compounds. Disclosed are mixtures of enantiomers or diastereomers.

The term “beta lactone”, as used herein, refers to a substituted or unsubstituted cyclic ester having a four-membered ring comprising an oxygen atom, a carbonyl group and two optionally substituted methylene groups. When unsubstituted, the beta lactone is referred to as beta-propiolactone (bPL). The beta lactones may be monosubstituted, disubstituted, trisubstituted, and tetrasubstituted. Such beta lactones may be further optionally substituted as defined herein. The beta lactones comprise a single lactone moiety. The beta lactones may comprise two or more four-membered cyclic ester moieties. Examples of beta lactones are shown in Table A (between paragraphs 65 and 66) of PCT Pub. WO2020/033267 incorporated herein by reference.

The terms “halo” and “halogen” as used herein refer to an atom selected from fluorine (fluoro, —F), chlorine (chloro, —Cl), bromine (bromo, —Br), and iodine (iodo, —I). The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms or 1 or 2 carbon atoms. Exemplary aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl. The term “heteroaliphatic,” as used herein, refers to aliphatic groups wherein one or more carbon atoms are independently replaced by one or more atoms selected from the group consisting of oxygen, sulfur, nitrogen, or phosphorus. One to six carbon atoms may be independently replaced by one or more of oxygen, sulfur, nitrogen, or phosphorus. Heteroaliphatic groups may be substituted or unsubstituted, branched or unbranched, cyclic or acyclic, and include saturated, unsaturated, or partially unsaturated groups. The term “unsaturated”, as used herein, means that a moiety has one or more double or triple bonds. The terms “cycloaliphatic”, “carbocycle”, or “carbocyclic”, used alone or as part of a larger moiety, refer to a saturated or partially unsaturated cyclic aliphatic monocyclic or polycyclic ring system, as described herein, having from 3 to 12 members, wherein the aliphatic ring system is optionally substituted as defined below and described herein. Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, norbornyl, 5damantly, and cyclooctadienyl. A cycloaliphatic group may have 3-6 carbons. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring.

The term “alkenyl,” as used herein, denotes a monovalent group derived from a straight- or branched-chain aliphatic moiety having at least one carbon-carbon double bond by the removal of a single hydrogen atom. The term “alkynyl,” as used herein, refers to a monovalent group derived from a straight- or branched-chain aliphatic moiety having at least one carbon-carbon triple bond by the removal of a single hydrogen atom. The term “alkoxy”, as used herein refers to an alkyl group, as previously defined, attached to the parent molecule through an oxygen atom. Examples of alkoxy, include but are not limited to, methoxy, ethoxy, propoxy, isopropoxy, n-butoxy, tert-butoxy, neopentoxy, and n-hexoxy. The term “acyl”, as used herein, refers to a carbonyl-containing functionality, e.g., —C(═O)R′, wherein R′ is hydrogen or an optionally substituted aliphatic, heteroaliphatic, heterocyclic, aryl, heteroaryl group, or is a substituted (e.g., with hydrogen or aliphatic, heteroaliphatic, aryl, or heteroaryl moieties) oxygen or nitrogen containing functionality (e.g., forming a carboxylic acid, ester, or amide functionality). The term “acyloxy”, as used here, refers to an acyl group attached to the parent molecule through an oxygen atom. The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring” wherein “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like, where the radical or point of attachment is on the aryl ring. The terms “heteroaryl” and “heteroar-”, used alone or as part of a larger moiety, e.g., “heteroaralkyl”, or “heteroaralkoxy”, refer to groups having 5 to 14 ring atoms, preferably 5, 6, or 9 ring atoms; having 6, 10, or 14 n electrons shared in a cyclic array; and having, in addition to carbon atoms, from one to five heteroatoms. The term “heteroaryl” may be used interchangeably with the terms “heteroaryl ring” and “heteroaryl group”, any of which terms include rings that are optionally substituted. The term “heteroatom” refers to nitrogen, oxygen, or sulfur, and includes any oxidized form of nitrogen or sulfur, and any quaternized form of a basic nitrogen. Heteroaryl groups include, without limitation, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, benzofuranyl and pteridinyl. The terms “heteroaryl” and “heteroar-”, as used herein, also include groups in which a heteroaryl ring is fused to one or more aryl, cycloaliphatic, or heterocyclyl rings, where the radical or point of attachment is on the heteroaryl ring. Nonlimiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be mono- or bicyclic. The term “heteroaralkyl” refers to an alkyl group substituted by a heteroaryl, wherein the alkyl and heteroaryl portions independently are optionally substituted. In certain embodiments, the term “5- to 10-membered heteroaryl” refers to a 5- to 6-membered heteroaryl ring having 1 to 3 heteroatoms independently selected from nitrogen, oxygen, or sulfur, or an 8- to 10-membered bicyclic heteroaryl ring having 1 to 4 heteroatoms independently selected from nitrogen, oxygen, or sulfur. The term “partially unsaturated” refers to a ring moiety that includes at least one double or triple bond. The term “partially unsaturated” is intended to encompass rings having multiple sites of unsaturation, but is not intended to include aryl or heteroaryl moieties, as herein defined.

As described herein, compounds disclosed may contain “optionally substituted” moieties. The term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned are those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein. As used herein the term “alkoxylated” means that one or more functional groups on a molecule (usually the functional group is an alcohol, amine, or carboxylic acid, but is not strictly limited to these) has appended to it a hydroxy-terminated alkyl chain. Alkoxylated compounds may comprise a single alkyl group or they may be oligomeric moieties such as hydroxyl-terminated polyethers. Alkoxylated materials can be derived from the parent compounds by treatment of the functional groups with epoxides. Unless otherwise specified, “a,” “an,” “the,” and “at least one” are used interchangeably and mean one or more than one. Electron withdrawing groups include halogen groups, nitro groups, ketones, cyano groups, carboxylic acids and carboxylates.

The compositions may be made by contacting PHA with a stabilizer. The stabilizer may one of three types: (1) an aliphatic carboxylic acid having a hydroxyl or thiol group, (2) a cyclic anhydride, or (3) a halo carboxylic acid.

Illustratively, carboxylic acids include those that are naturally occurring or derived from a naturally occurring carboxylic acid. Naturally occurring is one that may be found and isolated from an organism existing in nature. The acids may be saturated or unsaturated. The natural occurring carboxylic acid maybe any natural occurring carboxylic acid, for example, abietic acid, gallic acid, alginic acid, azelaic acid, caffeic acid, malic acid, pyruvic acid, niacin, citric acid, biotin, abietic acid, cholic resin, pectin, alginic acid, gum rosin (a mixture of naturally occurring natural acids) or combination thereof. The fatty acid may be any fatty acid derived from any animal fat or vegetable oil and maybe saturated or unsaturated. More desirably, the carboxylic acid having a hydroxyl occurs in a fruit. The carboxylic acid may be malic acid, citric acid, their thiol analogs, or mixture thereof.

The carboxylic acid typically has at least one hydroxyl or thiol in α, β, γ position to a carbonyl of an acid group in the carboxylic acid. Desirably, at least one hydroxyl or thiol is in the α, or β position. The carboxylic acid may be substituted with hydroxyl or thiol along its aliphatic backbone in any useful amount. Typically, the amount of substitution is equivalent to the carboxylic acid groups present or less in the carboxylic acid (i.e., equivalent ratio of COOH/[OH±SH]). The carboxylic acid may have a hydroxyl or thiol that is positioned between two carbonyls in differing α, β, γ positions, for example, in a diacid or triacid. For example, the position may be in the α, for one carbonyl and in the β position in another carboxylic acid group, but when the diacid only has hydroxyls in the α position, the thermal stabilization is lessened (e.g., tartaric acid). Each hydroxyl or thiol group may only be in the beta position. The carboxylic acid may be substituted with mixture of thiols and hydroxyls or be solely one or the other.

The carboxylic acid typically has at least one carboxylic acid group to any useful amount. More typically, there is from 1 or 2 to 4 or 6 hydroxyls or thiols. The carboxylic acid may be a small molecule or a polymer. For the purposes herein, small molecule is about less 1000 g/moles and polymer is greater than about 1000 g/moles. Even smaller molecules may be desirable for improved processibility and diffusivity such as those having at most about 500 g/moles or 300 g/moles.

When the stabilizer is a cyclic anhydride, it may be any cyclic anhydride, but typically is one having a 5 member ring, which may be further substituted or not. For example, the 5 member cyclic anhydride may be represented by:

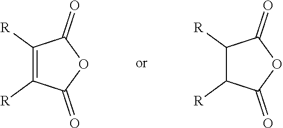

wherein R may any substituent such as alkyl, alkenyl or aryl group described previously, the two R,s may form a ring structure which may be aromatic and which may be substituted. The substituents may be electron withdrawing groups. The substituents may be electron withdrawing groups which do not interfere with the function of stabilizing the PHA's. The substituents may be halogens, carboxylate groups, carboxylic acids, and the like. Illustrative cyclic anhydride stabilizers include maleic anhydride and itaconic acid anhydride. Illustrative cyclic anhydrides include phthalates and substituted phathalates. In reference to the formulas disclosed the phtahlates have the R's form an aromatic ring which may be substituted. Exemplary phthalates are the following:

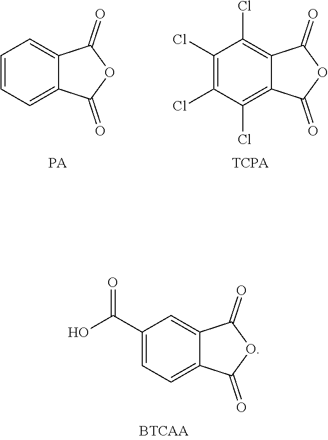 [SMILES: O=C1OC(=O)c2ccccc21 ; O=C1OC(=O)c2c(Cl)c(Cl)c(Cl)c(Cl)c21 ; O=C(O)c1ccc2c(c1)C(=O)OC2=O]

Any useful halo carboxylic acid may be used and may have aromatic and aliphatic groups. Typically, the halo carboxylic acid is a halo aliphatic acid (HAA). The halo carboxylic acid typically has an equivalent amount of halo and carboxylic groups. For example, the HAA may have 1 halo and 1 carboxylic group. The HAA may have any configuration such as described above, but typically is linear. The HAA is desirably a small molecule as defined previously. The HAA may be comprised of any halide such as Br or Cl. The HAA may be derived from naturally occurring carboxylic acids.

The PHA is one that may be formed from the ring opening of a lactone, or biosynthesized. In the biosynthesis process, the PHA is produced by manipulating the parameters during the fermentation there by stimulating the formation of PHA via an enzymatic pathway.

The PHA may be represented by:

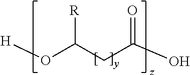

wherein R is aryl, arylalkenyl or alkenyl as described above, but typically R is H or a C₁ to C₁₈ or C₁₂ unsubstituted alkyl, y may be from 1 to 6 and typically is 1, and z may be any value resulting in a polymer have a molecular weight above about 10,000 g/moles (e.g., z is at least about 100 to 10,000). The PHA may be one comprised of a blend of PHA biosynthesized. In a particular blend, the blend may have a bimodal distribution indicated by a peak above 250,000 g/moles and one peak below 250,000 g/moles. Such blends bimodal distributed blends may be formed by blending biosynthesized PHAs with PHAs prepared by lactone ring opening polymerization. The PHAs prepared by ring-opening polymerization typically have a Mw of less than about 250,000 g/moles to about 10,000 g/moles.

PHA may have an Mw of 10,000 g/moles 100,000 g/moles to 300,000 g/moles, 500,000 g/moles, 1×10⁶ g/moles or 2×10⁶ g/mole. The copolymer may have a low polydispersity such as a polydispersity index (PDI) of 3.5 or less, 3.0 or, 2.5 or less or 2.2 or less. The polymer may have a PDI of 1.05 or greater, 1.1 or greater, 1.2 or greater, 1.5 or greater or 2.0 or greater. the PDI values recited refer to that measured by GPC using polymethylmethacrylate standards and standard computer programs to perfom the calculations . . . . The PDI values may be calculated without inclusion of GPC peaks arising from oligomers having Mn below about 5,000 g/mol, less than about 4,500, less than about 4,000, less than about 3,500, less than about 3,000, less than about 2,500, less than about 2,000, less than about 1,500, or less than about 1,000 g/mol.

The PHAs may be copolymers with other monomers so long as the polymer has similar decomposition characteristics. The PHAs may be comprised of PHAs where z and x vary. The PHA may be a block, graft, or random polymer. Examples of possible PHAs from ring opening polymerization of differing lactones are described in co-pending U.S. provisional application 63/224,137, filed Jul. 21, 2021 from paragraphs 20 to 25, now PCT Application US2022/037611 filed 19 Jul. 2022, both incorporated herein by reference. The biosynthesized PHAs typically is comprised of the polymerization units (residue of), 3-hydroxypropionate, 3-hydroxybutyrate, 3-hydroxyvalerate, 3-hydroxyhexanoate, 3-hydroxyoctonoate, 3-hexadecanoate. The PHA may be comprised of 3-hydroxypropionate (3HP), 3-hydroxybutyrate (3HP) or mixture thereof. The PHA may be comprised of a homopolymer of the aforementioned polymerization units or blend of homopolymers or copolymers thereof.

The contacting may involve any useful method for intermingling the PHA and stabilizer such that the stabilizer may be incorporated into and stabilize the PHA. For example, the contacting may involve merely physically mixing powders (particles typically less than 5 mm with the predominate of particles being less than 1 mm). The physically mixing may be done without the addition of a solvent or liquid. Exemplary mixers include those known in the chemical arts such as muller mixers and V-blenders. The contacting may occur simultaneous with the intermixing. For example, the PHA and stabilizer may both be dissolved in a solvent or the PHA is heated to a molten state and the stabilizer is added with the assistance of mechanical agitation. The dissolution may be aided thermally (e.g., heated above ambient temperatures (˜20° C.) in a closed or pressurized system). Typically, the temperature when forming the composition from a molten PHA is above about 100° C. to about 200° C. The solvent may be any that dissolves one or both the PHA and stabilizer in the amounts desired to effectuate the incorporation of the stabilizer in the PHA without the application of heat. Desirably, the solvent dissolves both the PHA and stabilizer to effectuate the intermixing of the stabilizer in the PHA. The solvent may be, for example, a chlorinated solvent, a cyclic or acyclic carbonate, ether, ester or ketone. Exemplary solvents include tetrahydrofuran, methylene chloride, chloroform, dimethyl carbonate, diethyl carbonate, propylene carbonate, ethylene carbonate, trimethylene carbonate, ethyl acetate or cyclohexanone. The stabilizer may be used in an amount sufficient to reduce the impact of impurities present in the PHA's on the molecular weight of the PHA's. The stabilizer is used in an amount from about 0.0001 percent by weight or greater based on the weight of the PHA's and the stabilizers, about 0.001 percent by weight or greater, about 0.01 percent by weight or greater, about 0.1 percent by weight or greater, about 0.5 percent by weight or greater or about 1.0 percent by weight or greater. The stabilizer is used in an amount from about 3 percent by weight or less based on the weight of the PHA's, about 5 percent by weight or less or about 10 percent by weight or less.

The intermixing may be any method such that the stabilizer is intermixed on a level that allows it to stabilize the PHA from undesired thermal degradation. Generally, this means the intermixing occurs to evenly distribute the stabilizer in the PHA. Thermal degradation is heat induced lowering of the Mw and too great a reduction of Mw may cause the PHA to become brittle. Without being limiting in any way, the stabilizer may scavenge metal or quaternary ammonium ions, act as a chain extender or end cap the PHA. Illustratively, the intermixing may be by simultaneously heating (melting) and extruding a dry mixture of the PHA and stabilizer. The PHA may be first introduced into an extruder and the stabilizer added further down the barrel of the extruder. Differing temperature profiles and points of introduction of PHA and stabilizer may be employed to produce the desired polymer molecular distributions. The application of heating may also be used to make shaped articles simultaneously forming the composition. As described, an extruder may be used to form the composition and then passed through a die to form a shaped article. Another example may be the physical mixture of the PHA, which by localized heating (e.g., 3D printing) become molten and form the composition and article. The composition may be a formed when making shaped articles in injection molding.

### Examples 1-18 and Comparative Examples 1-3

Polypropiolactone (PPL) homopolymer made via the ring-opening polymerization of beta-propiolactone (bPL) with tetramethylammonium acetate (TMAA) in methyl tert-butyl ether solvent (MTBE) was used (Mw=198 kDa; D=2.2). About 30 g of the PPL was weighed with each of the stabilizers shown in Table 1 at a concentration of 1% by weight of the PPL and stabilizer. The PPL and stabilizer were combined in a mortar and ground for 0.5 to 1 minute and stored in a vial until testing. The amount of initial molar mass remaining after heating to 100 to 120° C. for 30 minutes is determined by gel-permeation chromatography (CHCl₃; 1.0 mL/min at 40° C. versus PMMA polymer standards). The efficacy is the amount of the initial molar mass remaining after heating.

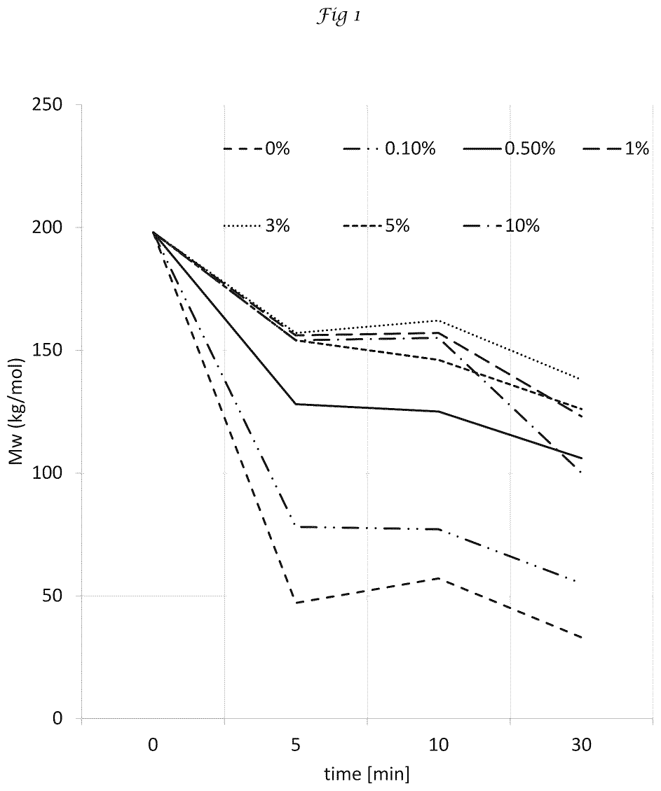

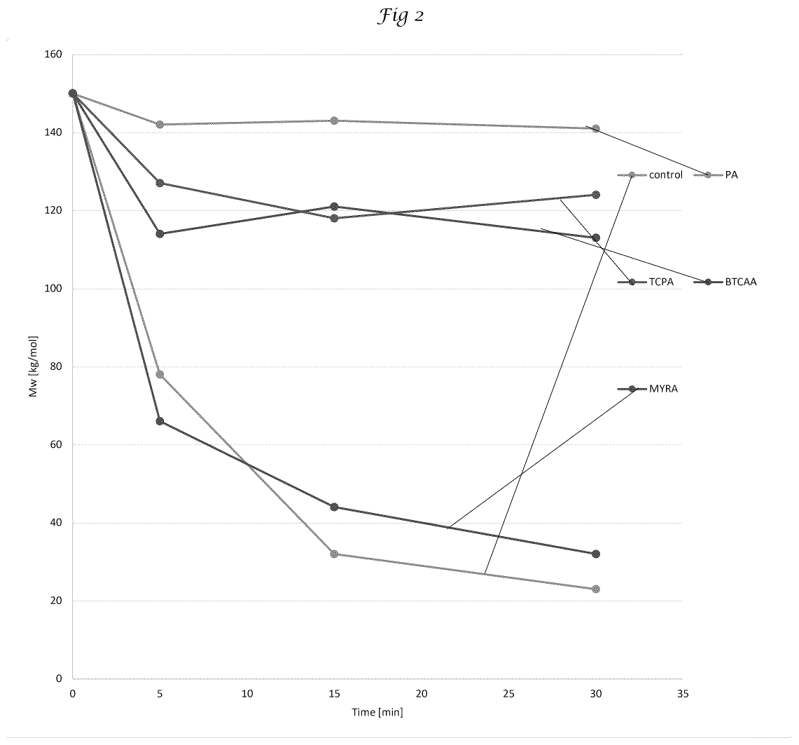

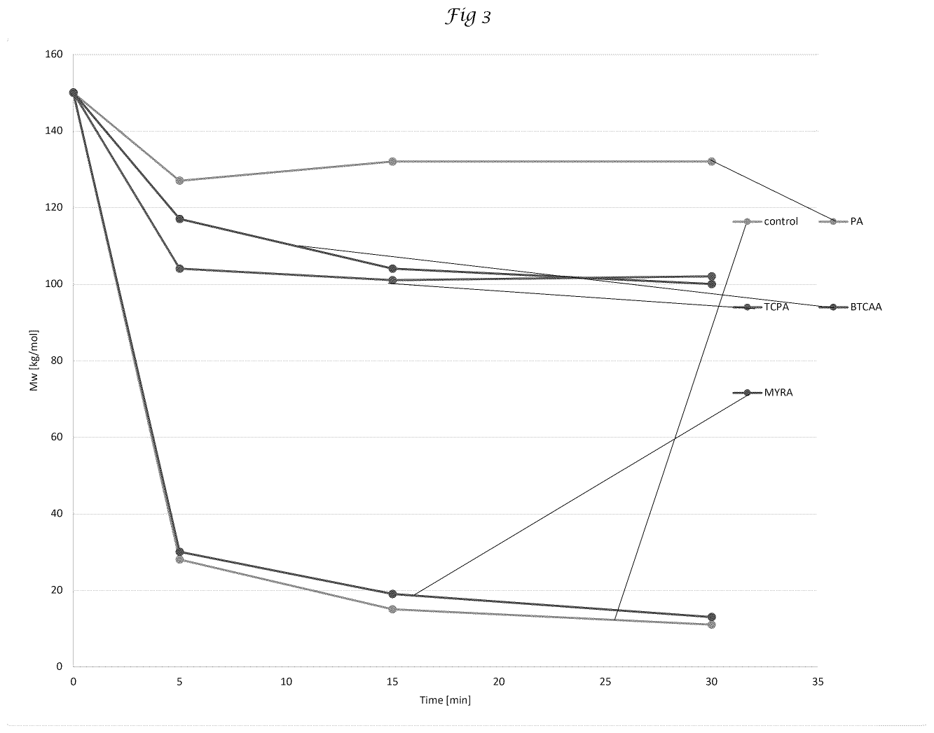

The above procedure is duplicated for malic acid stabilizer where the heating is to 120° C. and the amount malic acid is varied from none, 0.1%, 0.5%, 1%, 3%, 5%, and 10% and aliquots at differing times (initial, 5, 10 and 30 minutes) were taken and analyzed for Mw as described above and as shown in FIG. 1. From FIG. 1, it is apparent that there is an optimum amount of malic acid ranging from about 1% to 3% by weight of malic acid.

TABLE 1

| Example | Stabilizer^{a} | Efficacy^{b} |
|---|---|---|
| 1 | Maleic anhydride | 99% |
| 2 | Itaconic acid anhydride | 72% |
| 3 | Ethyl chloroacetate | 98% |
| 4 | Bromoacetic acid | 99% |
| 6 | Malic acid | 93% |
| 7 | Thiomalic acid | 98% |
| 8 | Citric acid | 89% |
| 9 | Tartaric acid | 53% |
| 10 | Benzoic acid | 56% |
| 11 | Salicyclic acid | 59% |
| 12 | Vanillic acid | 41% |
| 13 | Succinic acid | 59% |
| 14 | Oxalic acid | 65% |
| 15 | Itaconic acid | 46% |
| 16 | Diethyl fumarate | 28% |
| 17 | Dibutyl itaconate | 33% |
| 18 | Fumaric acid | 43% |
| Comp. 1 | None | 25% |
| Comp. 2 | 1,4, Bis-Bromomethyl-Benzene | 53% |
| Comp. 3 | 1-Bromobutane | 30% |

^{a}Stabilizer added at ~1 mass percent to Polypropiolactone polymer
^{b}Efficacy defined as the percentage calculated by dividing the Mw of the heated PHA by the M_{w} of the PHA before heating. The polymer sample is heated to 100 to 120° C. for 30 min.

### Examples 19 to 22 Phthalic Anhydride Based Stabilizers

Polypropiolactone Polymers were mixed with a number of Phthalate Anhydrides as shown below at 1 mass percent in the manner described in the previous examples. A comparative example was also performed using a non-cyclic anhydride. The samples were heated at 120° C. and 140° C. for 30 minutes and the mass of each sample is measured as described above at 0 about 5, 15 and 30 minutes respectively. A control sample without any stabilizer is also tested as described. The data for the samples tested as 120° C. is shown in FIG. 2 and the data for the samples tested as 140° C. is shown in FIG. 3. Structures of the stabilizers tested are

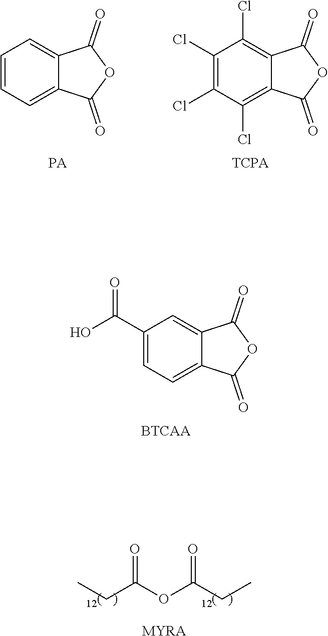

The data shows that the samples with Phthalic Anhydride and substitutes Phthalic anhydride provide the very good thermal stability. Aliphatic Anhydrides do not provide good thermal stability.

1. A composition comprising a polyhydroxyalkanoate formed from the ring opening of a lactone and a stabilizer comprising of one or more of an aliphatic carboxylic acid having a hydroxyl or thiol group, a cyclic anhydride; having a 5 member ring or a halo carboxylic acid wherein amount of the stabilizer is about 0.0001 to about 10 percent by weight or less based on the weight of the polyhydroxyalkanoate and the stabilizer.

2. The composition of claim 1, wherein the aliphatic carboxylic acid has at least one hydroxyl or thiol in an α, β, or γ position of a carbonyl of the aliphatic acid.

3-7. (canceled)

8. The composition of claim 1, wherein the aliphatic carboxylic acid has 2 to 4 carboxylic acid groups.

9. The composition of claim 8, wherein the aliphatic carboxylic acid is comprised of at least one of: malic acid, citric acid and their thiol analogs.

10. The composition of claim 1, wherein the cyclic anhydride is maleic anhydride.

11. A composition of claim 1, wherein the halo carboxylic acid is comprised of aromatic groups.

12. A composition of claim 1, wherein the halo carboxylic acid is aliphatic.

13-14. (canceled)

15. The composition of claim 1, wherein the aliphatic carboxylic acid is malic acid.

16. The composition of claim 1 wherein the stabilizer is phthalic anhydride or a substituted phthalic anhydride.

17. A method comprising (i) contacting a polyhydroxyalkanoate formed from the ring opening of a lactone and at least one stabilizer comprising of one or more of an aliphatic carboxylic acid having a hydroxyl or thiol group, a cyclic anhydride, and a halo carboxylic acid and
(ii) intermixing the polyhydroxyalkanoate and the stabilizer; wherein amount of the stabilizer is about 0.0001 to about 10 percent by weight or less based on the weight of the polyhydroxyalkanoate and the stabilizer.

18. The method of claim 17, wherein the intermixing is carried out by heating.

19. The method of claim 17, wherein the intermixing is aided by mechanical agitation.

20. The method of claim 19, wherein the intermixing is performed at least in part by solubilizing in a solvent at least one of the polyhydroxyalkanoate and stabilizer.

21-22. (canceled)

23. The method of claim 17, wherein polyhydroxyalkanoate is comprised of a residue of a beta propiolactone or substituted beta lactone.

24. The method of claim 23, wherein the residue is comprised of the beta propiolactone residue.

25-26. (canceled)

27. The method of claim 17, wherein the polyhydroxyalkanoate is a polyhydroxypropionate, polyhydroxybutyrate, copolymers or blends of these.

28. The method of claim 17, wherein the stabilizer is used in an amount of about 0.01 to about 5 percent by weight or less based on the weight of the polyhydroxyalkanoate and the stabilizer.

29. The composition of claim 1, wherein the stabilizer is used in an amount of about 0.01 to about 5 percent by weight or less based on the weight of the polyhydroxyalkanoate and the stabilizer.

30. A composition comprising a polyhydroxyalkanoate and a stabilizer comprising of one or more of an aliphatic carboxylic acid having a hydroxyl or thiol group selected from malic acid and its thiol analogs; phthalic anhydride or a substituted phthalic anhydride or a halo carboxylic acid wherein the stabilizer is used in an amount of about 0.0001 to about 10 percent by weight or less based on the weight of the polyhydroxyalkanoate and the stabilizer.

31. The composition of claim 30, wherein the stabilizer is used in an amount of about 0.01 to about 5 percent by weight or less based on the weight of the polyhydroxyalkanoate and the stabilizer.
